(19) United States
(12) Patent Application Publication
(10) Pub. No.: US 2018/0217559 A1
(43) Pub. Date: Aug. 2, 2018

(54) TIMEPIECE COMPONENT AND TIMEPIECE

(71) Applicant: Seiko Epson Corporation, Tokyo (JP)

(72) Inventor: Daiki FURUSATO, Ina (JP)

(21) Appl. No.: 15/877,643

(22) Filed: Jan. 23, 2018

(30) Foreign Application Priority Data
Jan. 30, 2017 (JP) 2017-014555
Nov. 9, 2017 (JP) 2017-216498

(51) Int. Cl. G04B 37/22; G04B 45/00

(52) U.S. Cl. CPC G04B 37/22; G04B 45/0076

(57) ABSTRACT

A timepiece component according to the invention includes a metallic luster portion which is constituted by a first material containing a nitride or a carbide of Ti, a nitride or a carbide of Cr, or a metal material, and a toning film which is constituted by a multilayer film of a metal oxide. The toning film preferably includes a layer constituted by a material containing at least one member selected from the group consisting of Ta₂O₅, SiO₂, TiO₂, Al₂O₃, ZrO₂, Nb₂O₅, and HfO₂. The timepiece component is preferably a crystal, a dial, a case, or a band.

### BACKGROUND

### 1. Technical Field

The present invention relates to a timepiece component and a timepiece.

### 2. Related Art

A timepiece is required to have a function as a practical item, and is also required to have an aesthetic property (aesthetic appearance) as an ornamental item.

Therefore, a noble metal material having an excellent texture is used in a timepiece component such as a dial or a case (see, for example, JP-A-2009-69078 (Patent Document 1)).

However, a noble metal material is generally expensive, and also in relation to reserves or the like, there has been a demand to avoid excess use of a noble metal material.

### SUMMARY

An advantage of some aspects of the invention is to provide a timepiece component having an excellent appearance even without using a noble metal as a main material, and also to provide a timepiece including the timepiece component.

The advantage can be achieved by the following configurations.

A timepiece component according to an aspect of the invention includes a metallic luster portion which is constituted by a first material containing a nitride or a carbide of Ti, a nitride or a carbide of Cr, or a metal material, and exhibits a metallic luster, and a toning film which is constituted by a multilayer film of a metal oxide, and has a function of adjusting a color tone.

According to this configuration, a timepiece component having an excellent appearance can be provided even without using a noble metal as a main material.

In the timepiece component according to the aspect of the invention, it is preferred that the metallic luster portion is a substrate constituted by the first material.

According to this configuration, the structure of the timepiece component can be further simplified, and the productivity of the timepiece component can be further enhanced.

In the timepiece component according to the aspect of the invention, it is preferred that the metallic luster portion is a coating film provided on a substrate constituted by a material containing substantially no nitride or carbide of Ti, nitride or carbide of Cr, or metal material.

According to this configuration, the range of choices for the constituent material or the like of the substrate is expanded, and therefore, the range of choices for the molding method for the timepiece component, the range of choices for the placement site of the timepiece component in a timepiece, etc. can be further expanded. Further, the amount of a metal material used in the timepiece component as a whole can be further decreased.

In the timepiece component according to the aspect of the invention, it is preferred that the metallic luster portion has a thickness of 30 nm or more.

According to this configuration, the luster and aesthetic property of the timepiece component as a whole can be further enhanced.

In the timepiece component according to the aspect of the invention, it is preferred that the toning film includes a layer constituted by a material containing at least one member selected from the group consisting of Ta₂O₅, SiO₂, TiO₂, Al₂O₃, ZrO₂, Nb₂O₅, and HfO₂.

According to this configuration, the aesthetic property of the timepiece component can be further enhanced, and also the range of the color tone which can be expressed by the timepiece component as a whole can be further expanded. Further, these compounds are materials having particularly high chemical stability among various types of metal oxides, and therefore can further enhance the stability of the appearance and the durability of the timepiece component as a whole.

In the timepiece component according to the aspect of the invention, it is preferred that the toning film has a thickness of 100 nm or more and 2000 nm or less.

According to this configuration, the aesthetic property of the timepiece component can be further enhanced, and the range of the color which can be expressed (color reproducible range) can be further expanded, and also unintended peel-off or the like of the toning film can be more effectively prevented, and therefore, the durability and reliability of the timepiece component can be further enhanced, and also the productivity of the timepiece component can be further enhanced.

In the timepiece component according to the aspect of the invention, it is preferred that each layer constituting the toning film has a thickness of 10 nm or more and 300 nm or less.

According to this configuration, the aesthetic property of the timepiece component can be further enhanced, and the color reproducible range can be further expanded, and also unintended peel-off or the like of the toning film can be more effectively prevented, and therefore, the durability and reliability of the timepiece component can be further enhanced.

In the timepiece component according to the aspect of the invention, it is preferred that the metallic luster portion is constituted by a material containing one of Cr and Al.

According to this configuration, the timepiece component as a whole can favorably exhibit a bluish luxurious metallic luster.

In the timepiece component according to the aspect of the invention, it is preferred that the metallic luster portion includes a first region and a second region which is provided in the form of a layer overlapping with the first region on a side closer to the toning film than the first region, and the second region is constituted by a material different from that of the first region.

According to this configuration, subtle color adjustment can be performed, and the color reproducible range of the timepiece component as a whole can be further expanded, and thus, the aesthetic property of the timepiece component can be further enhanced. In addition, the aesthetic property of the timepiece component can be enhanced while further suppressing the amount of a metal used therein as a whole.

In the timepiece component according to the aspect of the invention, it is preferred that the first region is constituted by TiN, and the second region is constituted by a metal material containing Ti, Cr, Al, or Fe.

According to this configuration, a particularly highly luxurious gold color can be expressed.

In the timepiece component according to the aspect of the invention, it is preferred that the first region is provided in the form of a layer.

According to this configuration, the range of choices for the constituent material or the like of the substrate and the first region is expanded, and for example, even a material which is difficult to cast or the like can be favorably used. Further, the amount of a metal material used in the timepiece component as a whole can be further decreased.

In the timepiece component according to the aspect of the invention, it is preferred that the timepiece component is a crystal, a dial, a case, or a band.

These components (timepiece components) greatly affect the appearance of a timepiece as a whole, and therefore, by applying the invention to these components, the aesthetic property of the timepiece as a whole can be further enhanced.

A timepiece according to an aspect of the invention includes the timepiece component according to the aspect of the invention.

According to this configuration, a timepiece having an excellent appearance can be provided even without using a noble metal as a main material.

### BRIEF DESCRIPTION OF THE DRAWINGS

The invention will be described with reference to the accompanying drawings, wherein like numbers reference like elements.

FIG. 1 is a cross-sectional view schematically showing a first embodiment of a timepiece component according to the invention.

FIG. 2 is a cross-sectional view schematically showing a second embodiment of a timepiece component according to the invention.

FIG. 3 is a cross-sectional view schematically showing a third embodiment of a timepiece component according to the invention.

FIG. 4 is a cross-sectional view schematically showing a fourth embodiment of a timepiece component according to the invention.

FIG. 5 is a cross-sectional view schematically showing a fifth embodiment of a timepiece component according to the invention.

FIG. 6 is a cross-sectional view schematically showing a sixth embodiment of a timepiece component according to the invention.

FIG. 7 is a partial cross-sectional view schematically showing a preferred embodiment of a timepiece (wristwatch) according to the invention.

### DESCRIPTION OF EXEMPLARY EMBODIMENTS

Hereinafter, preferred embodiments will be described in detail with reference to the accompanying drawings.

### Timepiece Component

First, a timepiece component according to the invention will be described.

### First Embodiment

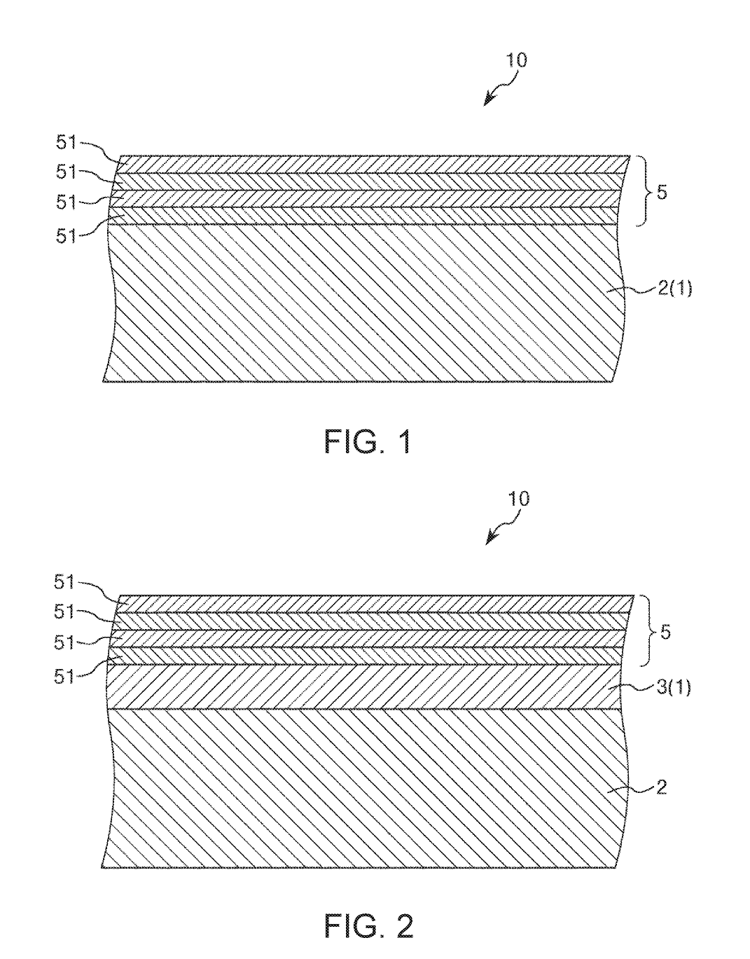

FIG. 1 is a cross-sectional view schematically showing a first embodiment of a timepiece component according to the invention.

A timepiece component 10 includes a metallic luster portion 1 which is constituted by a first material containing a nitride or a carbide of Ti, a nitride or a carbide of Cr, or a metal material, and exhibits a metallic luster, and a toning film 5 which is constituted by a multilayer film of a metal oxide (a stacked body of a plurality of metal oxide layers 51), and has a function of adjusting a color tone of the timepiece component 10 as a whole.

The “nitride” as used herein refers to a metal compound containing nitrogen (N) and includes a carbonitride and the like. Further, the “carbide” as used herein refers to a metal compound containing carbon (C) and includes a carbonitride and the like.

The metallic luster portion 1 is a portion which exhibits a metallic luster.

The toning film 5 has a function of adjusting a color tone of the timepiece component 10 as a whole while making use of the metallic luster of the metallic luster portion 1.

The view point of an observer is on the upper side in FIG. 1 (on the surface side on which the toning film 5 is provided of the timepiece component 10 (on the side closer to the toning film 5 than the metallic luster portion 1 of the timepiece component 10)) (the same applies to FIGS. 2 to 6 mentioned below).

According to such a configuration, the timepiece component 10 which has an excellent appearance (an appearance exhibiting a metallic luster), particularly a luxurious appearance can be provided even without using a noble metal as a main material. Further, even if a noble metal is used, the amount of the noble metal to be used can be suppressed. More specifically, for example, a luxurious appearance as being exhibited by a noble metal material can be obtained even if the timepiece component contains substantially no noble metal. Further, a noble metal generally has a characteristic that it is susceptible to scratches or the like, however, according to the configuration as described above, the scratch resistance, etc. of the timepiece component 10 as a whole can be enhanced. In particular, in the timepiece component 10, both excellent appearance and excellent scratch resistance can be achieved. Further, various color tones such as a metallic look with a bluish luster and a metallic look with a reddish luster, which are hardly expressed only by a metal material, can be expressed, and an appearance with a color tone which cannot be obtained when only a metal material (particularly, a noble metal material) is merely used can be obtained. That is, the range of the color which can be expressed (color reproducible range) can be further expanded. Further, even if the metallic luster portion 1 is constituted by a metal material (for example, a metal material or the like, which has relatively low chemical stability, and with which a reaction such as oxidation is likely to proceed), by covering the metallic luster portion 1 with the toning film 5 constituted by an oxide having excellent chemical stability, the stability of the appearance and the durability of the timepiece component 10 as a whole are improved.

In particular, in the timepiece component 10 according to this embodiment, the metallic luster portion 1 is a substrate 2 constituted by the first material. In other words, the timepiece component 10 according to this embodiment includes the substrate 2 which functions as the metallic luster portion 1 and the toning film 5.

According to this, the structure of the timepiece component 10 can be further simplified, and the productivity of the timepiece component 10 can be further enhanced.

### Substrate (Metallic Luster Portion)

In this embodiment, the substrate 2 (metallic luster portion 1) is constituted by a first material containing a nitride or a carbide of Ti, a nitride or a carbide of Cr, or a metal material.

The metal material constituting the metallic luster portion 1 is preferably a metal which is less noble than a noble metal, and includes, for example, Al, Ti, V, Cr, Fe, Co, Ni, Cu, Zn, Zr, Nb, Mo, In, Sn, Hf, Ta, W, Bi, and Mg, and alloys containing at least one member thereof. It should be noted that this does not preclude the inclusion of a small amount of a noble metal.

In particular, when the metallic luster portion 1 is constituted by a material containing one of Cr and Al, the timepiece component 10 as a whole can favorably exhibit a bluish luxurious metallic luster.

Further, when the metallic luster portion 1 is constituted by a nitride of Ti or Cr, the timepiece component 10 as a whole can favorably exhibit a luxurious gold appearance (an appearance similar to Au as a simple substance).

Further, when the metallic luster portion 1 is constituted by a carbide of Ti, the timepiece component 10 as a whole can favorably exhibit a luxurious blackish appearance. In particular, the timepiece component 10 as a whole can exhibit a blackish red or blackish blue appearance or the like which is particularly difficult to express in the related art.

When the metallic luster portion 1 is constituted by a material containing a carbonitride of Ti, for example, a color tone similar to pink gold can be favorably expressed.

It is preferred that the metallic luster portion 1 has a sufficiently low content of a noble metal element (Au, Ag, Pt, Pd, Rh, Ir, Ru, or Os), and the content of a noble metal element (when a plurality of types of noble metal elements are contained, the sum of the contents of these elements) in the metallic luster portion 1 is preferably 1.0 mass % or less, more preferably 0.5 mass % or less, further more preferably 0.1 mass % or less.

According to this, the effect of obtaining an excellent appearance of the invention is more remarkably exhibited even without using a noble metal as a main material.

The metallic luster portion 1 may contain a component other than the nitride and the carbide of Ti, the nitride and the carbide of Cr, and the metal material as long as it has a metallic luster. However, the content of the component other than the above-mentioned materials (the nitride and the carbide of Ti, the nitride and the carbide of Cr, and the metal material) in the metallic luster portion 1 is preferably 5 mass % or less, more preferably 1 mass % or less.

The substrate 2 may have a uniform composition in the respective portions, or may have a portion having a different composition.

The metallic luster portion 1 has a thickness of preferably 30 nm or more, more preferably 40 nm or more, further more preferably 50 nm or more.

According to this, the luster and aesthetic property of the timepiece component 10 as a whole can be further enhanced.

The shape and size of the substrate 2 are not particularly limited, and are generally determined based on the shape and size of the timepiece component 10. Further, in the substrate 2, an engraved pattern of letters, numbers, symbols, a design, or the like may be provided.

The substrate 2 may be subjected to, for example, surface processing such as mirror finish, streaked finish, or sand blast finish on the surface.

According to this, it is possible to impart variations to the lustrous texture of the surface of the timepiece component 10, and thus, the aesthetic property of the timepiece component 10 can be further improved. The mirror finish can be performed using, for example, a known polishing method, and for example, buff (fabric) polishing, barrel polishing, another mechanical polishing, or the like can be adopted.

In the timepiece component 10 produced using the substrate 2 subjected to such surface processing, glare or the like is suppressed as compared with those obtained by directly performing surface processing for the respective types of films to be described in detail later, and therefore, the aesthetic property is particularly enhanced. Further, the respective types of films to be described in detail later are generally relatively thin, and when surface processing is directly performed for the films, a defect such as chipping or peeling off is likely to occur in the films when performing the surface processing, and the production yield of the timepiece component 10 is significantly decreased in some cases. However, by performing surface processing for the substrate 2, the occurrence of such a problem can be effectively prevented, and also the film thickness is relatively thin, and therefore, deterioration of the aesthetic property due to the surface processing does not occur. Further, the surface processing for the substrate 2 can be easily performed under mild conditions as compared with the surface processing for the respective types of films to be described in detail later.

### Toning Film

The toning film 5 is constituted by a multilayer film of a metal oxide. In other words, the toning film 5 is a stacked body including a plurality of metal oxide layers 51.

The toning film 5 (metal oxide layer 51) may be any as long as it is constituted by an oxide of a metal material, but preferably includes layers (metal oxide layers 51) constituted by a material containing at least one member selected from the group consisting of Ta₂O₅, SiO₂, TiO₂, Al₂O₃, ZrO₂, Nb₂O₅, and HfO₂, more preferably includes layers constituted by mutually different materials selected from the group as the plurality of metal oxide layers 51.

According to this, the aesthetic property of the timepiece component 10 can be further enhanced, and also the range of the color tone which can be expressed by the timepiece component 10 as a whole can be further expanded. Further, these compounds are materials having particularly high chemical stability among various types of metal oxides, and therefore can further enhance the stability of the appearance and the durability of the timepiece component 10 as a whole.

Above all, Al₂O₃ and HfO₂ are materials having a particularly high hardness, and therefore can provide not only chemical durability, but also excellent durability to mechanical force.

The toning film 5 (metal oxide layer 51) may be any as long as it is mainly constituted by a metal oxide, and may contain a component other than the metal oxide. However, the content of the component other than the metal oxide in the toning film 5 (metal oxide layer 51) is preferably 5 mass % or less, more preferably 1 mass % or less.

The thickness of the toning film 5 is preferably 100 nm or more and 2000 nm or less, more preferably 150 nm or more and 1000 nm or less, further more preferably 200 nm or more and 800 nm or less.

According to this, the aesthetic property of the timepiece component 10 can be further enhanced, and the color reproducible range can be further expanded, and also unintended peel-off or the like of the toning film 5 can be more effectively prevented, and therefore, the durability and reliability of the timepiece component 10 can be further enhanced, and also the productivity of the timepiece component 10 can be further enhanced.

The thickness of each layer (each metal oxide layer 51) constituting the toning film 5 is preferably 10 nm or more and 300 nm or less, more preferably 15 nm or more and 200 nm or less, further more preferably 25 nm or more and 150 nm or less.

According to this, the aesthetic property of the timepiece component 10 can be further enhanced, and the color reproducible range can be further expanded, and also unintended peel-off or the like of the toning film 5 can be more effectively prevented, and therefore, the durability and reliability of the timepiece component 10 can be further enhanced.

The number of metal oxide layers 51 constituting the toning film 5 is preferably 2 or more, more preferably 3 or more.

According to this, the aesthetic property of the timepiece component 10 can be further enhanced, and the color reproducible range can be further expanded, and also unintended peel-off or the like of the toning film 5 can be more effectively prevented, and therefore, the durability and reliability of the timepiece component 10 can be further enhanced.

The forming method for the toning film 5 is not particularly limited, and includes, for example, a coating method such as spin coating, dipping, coating with a brush, spray coating, electrostatic coating, and electrodeposition coating, a wet plating method such as electrolytic plating, immersion plating, and electroless plating, a chemical vapor deposition (CVD) method such as thermal CVD, plasma CVD, and laser CVD, a dry plating method (gas phase deposition method) such as vacuum vapor deposition, sputtering, and ion plating, and thermal spraying, but is preferably a dry plating method (gas phase deposition method).

By applying a dry plating method (gas phase deposition method) as the forming method for the toning film 5, the toning film 5 which has a uniform film thickness, is homogeneous, and has particularly excellent adhesion to the substrate 2 or the like can be reliably formed. As a result, the aesthetic appearance and durability of the timepiece component 10 can be particularly enhanced.

Further, by applying a dry plating method (gas phase deposition method) as the forming method for the toning film 5, even if the respective metal oxide layers 51 constituting the toning film 5 to be formed are relatively thin, the variation in the film thickness can be sufficiently reduced. Therefore, this is also advantageous to the improvement of the reliability of the timepiece component 10.

Further, by applying a dry plating method (gas phase deposition method) as the forming method for the toning film 5, the content of oxygen in the respective portions (respective metal oxide layers 51) in the toning film 5 can be more reliably controlled.

Among the dry plating methods (gas phase deposition methods) as described above, ion plating is particularly preferred.

By applying ion plating as the forming method for the toning film 5, the effect as described above becomes more remarkable. That is, by applying ion plating as the forming method for the toning film 5, the toning film 5 which has a uniform film thickness, is homogeneous, and has particularly excellent adhesion to the substrate 2 or the like can be more reliably formed. As a result, the aesthetic appearance and durability of the timepiece component 10 to be obtained finally can be further enhanced.

Further, by applying ion plating as the forming method for the toning film 5, even if the respective metal oxide layers 51 constituting the toning film 5 to be formed are relatively thin, the variation in the film thickness can be particularly reduced.

Further, by applying ion plating as the forming method for the toning film 5, the content of oxygen in the respective portions (respective metal oxide layers 51) in the toning film 5 can be more reliably controlled.

Further, when the toning film 5 is formed by a dry plating method, for example, by setting a plurality of targets, the respective metal oxide layers 51 constituting the toning film 5 can be formed successively in the same device without taking out the substrate 2 from the device.

According to this, the adhesion between the respective layers constituting the toning film 5 can be particularly enhanced, and also the productivity of the timepiece component 10 is improved.

### Second Embodiment

Next, a timepiece component according to a second embodiment will be described.

FIG. 2 is a cross-sectional view schematically showing the second embodiment of the timepiece component according to the invention. In the following description, different points from the above-mentioned embodiment will be mainly described, and the description of the same matter will be omitted.

In a timepiece component 10 according to this embodiment, a substrate 2 which is constituted by a material containing substantially no nitride or carbide of Ti, nitride or carbide of Cr, or metal material, a coating film 3 which is constituted by a first material and covers the substrate 2, and a toning film 5 which covers the coating film 3 are stacked in this order. In other words, in the timepiece component 10 according to this embodiment, a metallic luster portion 1 is the coating film 3 provided on the substrate 2 which is constituted by a material containing substantially no nitride or carbide of Ti, nitride or carbide of Cr, or metal material.

According to this, by providing the coating film 3 serving as the metallic luster portion 1 as a portion different from the substrate 2, the range of choices for the constituent material or the like of the substrate 2 is expanded. For example, a glass, a ceramic, a plastic material, or the like can also be favorably used as the constituent material of the substrate 2, and the range of choices for the molding method for the timepiece component 10, the range of choices for the placement site of the timepiece component 10 in a timepiece, etc. can be further expanded. Further, the amount of a metal material used in the timepiece component 10 as a whole can be further decreased. Accordingly, this can contribute to, for example, the weight reduction of the timepiece component 10. Further, the radio wave transmission property of the timepiece component 10 can be enhanced, and for example, the timepiece component 10 can be favorably applied to a radio-controlled timepiece or the like. Further, by using a substrate constituted by a material having a light transmission property as the substrate 2 and also making the thickness of the coating film 3 relatively thin, a sufficient light transmission property can be ensured while allowing the timepiece component 10 as a whole to exhibit excellent luster and aesthetic property. As a result, the timepiece component 10 can be favorably applied to, for example, a component required to have a light transmission property such as a crystal or a see-through back cover.

### Substrate

In this embodiment, examples of the constituent material of the substrate 2 include glass materials such as sapphire glass, soda-lime glass, crystalline glass, quartz glass, lead glass, potassium glass, borosilicate glass, and alkali-free glass, ceramic materials such as alumina and titania, and plastic materials such as various types of thermoplastic resins and various types of curable resins.

In this embodiment, the substrate 2 may be any as long as it contains substantially no nitride or carbide of Ti, nitride or carbide of Cr, or metal material, but may contain a nitride or a carbide of Ti, a nitride or a carbide of Cr, or a metal material as, for example, a filler, an inevitable component, or the like if the amount is small. For example, the substrate 2 may contain a nitride and a carbide of Ti, a nitride and a carbide of Cr, and a metal material in such an amount that the sum of the contents of these materials is 5 mass % or less. In such a case, the effect as described above is sufficiently obtained.

### Coating Film (Metallic Luster Portion)

In this embodiment, the coating film 3 functions as the metallic luster portion 1.

The constituent material of the coating film 3 is the same as that cited for the substrate 2 (metallic luster portion 1) in the above-mentioned embodiment. That is, in this embodiment, the coating film 3 is constituted by the first material.

The thickness of the coating film 3 is preferably 30 nm or more and 5000 nm or less, more preferably 40 nm or more and 3000 nm or less, furthermore preferably 50 nm or more and 500 nm or less.

According to this, the luster and aesthetic property of the timepiece component 10 as a whole can be further enhanced, and also unintended peel-off or the like of the coating film 3 can be more effectively prevented, and therefore, the durability of the timepiece component 10 can be further enhanced, and also the productivity of the timepiece component 10 can be further enhanced.

The coating film 3 may have a uniform composition in the respective portions, or may have a portion having a different composition. For example, the coating film 3 may be constituted by a gradient material in which the composition changes in a gradient manner (for example, a gradient material or the like in which the composition changes in a gradient manner in the thickness direction) or the like.

The forming method for the coating film 3 is not particularly limited, and includes, for example, a coating method such as spin coating, dipping, coating with a brush, spray coating, electrostatic coating, and electrodeposition coating, a wet plating method such as electrolytic plating, immersion plating, and electroless plating, a chemical vapor deposition (CVD) method such as thermal CVD, plasma CVD, and laser CVD, a dry plating method (gas phase deposition method) such as vacuum vapor deposition, sputtering, and ion plating, and thermal spraying, but is preferably a dry plating method (gas phase deposition method).

By applying a dry plating method (gas phase deposition method) as the forming method for the coating film 3, the coating film 3 which has a uniform film thickness, is homogeneous, and has particularly excellent adhesion to the substrate 2 or the like can be reliably formed. As a result, the aesthetic appearance and durability of the timepiece component 10 can be particularly enhanced.

Further, by applying a dry plating method (gas phase deposition method) as the forming method for the coating film 3, even if the coating film 3 to be formed is relatively thin, the variation in the film thickness can be sufficiently reduced. Therefore, this is also advantageous to the improvement of the reliability of the timepiece component 10.

Among the dry plating methods (gas phase deposition methods) as described above, ion plating is particularly preferred.

By applying ion plating as the forming method for the coating film 3, the effect as described above becomes more remarkable. That is, by applying ion plating as the forming method for the coating film 3, the coating film 3 which has a uniform film thickness, is homogeneous, and has particularly excellent adhesion to the substrate 2 or the like can be more reliably formed. As a result, the aesthetic appearance and durability of the timepiece component 10 to be obtained finally can be further enhanced.

Further, by applying ion plating as the forming method for the coating film 3, even if the coating film 3 to be formed is relatively thin, the variation in the film thickness can be particularly reduced.

### Third Embodiment

Next, a timepiece component according to a third embodiment will be described.

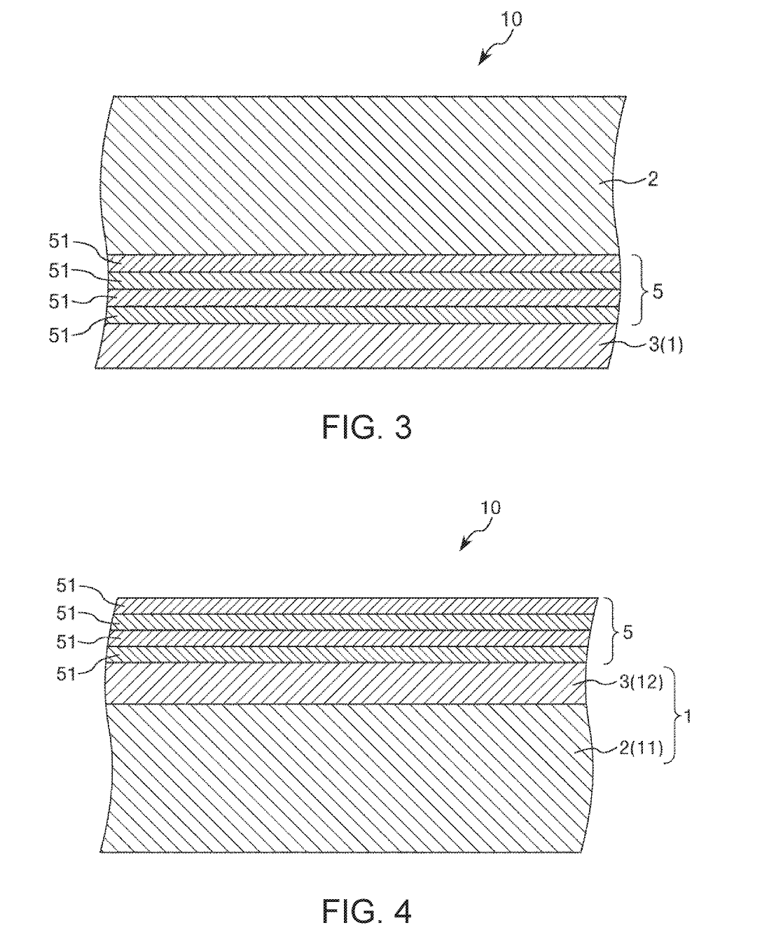

FIG. 3 is a cross-sectional view schematically showing the third embodiment of the timepiece component according to the invention. In the following description, different points from the above-mentioned embodiments will be mainly described, and the description of the same matter will be omitted.

In a timepiece component 10 according to this embodiment, a substrate 2 has a light transmission property, and the substrate 2, a toning film 5, and a coating film 3 (metallic luster portion 1) are stacked in this order.

In this manner, the placement of the respective members constituting the timepiece component 10 may be different from that described above.

Further, as in this embodiment, by stacking the substrate 2, the toning film 5, and the coating film 3 (metallic luster portion 1) in this order, an observer can be allowed to visually recognize the toning film 5 and the coating film 3 (metallic luster portion 1) through the substrate 2 having a light transmission property, and therefore, the exposure of the toning film 5 and the like to the outside can be avoided. Accordingly, the occurrence of damage (for example, scratches, peel-off, etc.) to the toning film 5 and the coating film 3 (metallic luster portion 1) due to an external force such as a scratchal force can be more effectively prevented, and thus, the durability of the timepiece component 10 can be further enhanced.

The substrate 2 may be any as long as it has a light transmission property, however, the visible light transmittance (for example, the light transmittance at a wavelength of 550 nm) of the substrate 2 is preferably 80% or more, more preferably 85% or more, furthermore preferably 90% or more.

According to this, the effect of placement of the respective members as described above is obtained, and also the aesthetic property of the timepiece component 10 can be further enhanced.

### Fourth Embodiment

Next, a timepiece component according to a fourth embodiment will be described.

FIG. 4 is a cross-sectional view schematically showing the fourth embodiment of the timepiece component according to the invention. In the following description, different points from the above-mentioned embodiments will be mainly described, and the description of the same matter will be omitted.

In a timepiece component 10 according to this embodiment, a substrate 2 (a first region 11 of a metallic luster portion 1) which is constituted by a first material, a coating film 3 (a second region 12 of the metallic luster portion 1) which is constituted by a first material, and a toning film 5 which covers the coating film 3 are stacked in this order, and the substrate 2 and the coating film 3 are constituted by mutually different materials. In other words, in this embodiment, the metallic luster portion 1 includes the first region 11 and the second region 12 which is provided in the form of a layer overlapping with the first region 11 on a side closer to the toning film 5 than the first region 11, and the second region 12 is constituted by a material different from that of the first region 11.

According to this, subtle color adjustment can be performed, and the color reproducible range of the timepiece component 10 as a whole can be further expanded, and thus, the aesthetic property of the timepiece component 10 can be further enhanced. In addition, the aesthetic property of the timepiece component 10 can be enhanced while further suppressing the amount of a metal used therein as a whole.

The thickness of the first region 11 is preferably 20 nm or more, more preferably 25 nm or more, further more preferably 30 nm or more.

According to this, the luster and aesthetic property of the timepiece component 10 as a whole can be further enhanced.

The thickness of the second region 12 is preferably 30 nm or less, more preferably 20 nm or less, further more preferably 10 nm or less.

According to this, the aesthetic property of the timepiece component 10 can be further enhanced, and also unintended peel-off or the like of the second region 12 can be more effectively prevented, and therefore, the durability and reliability of the timepiece component 10 can be further enhanced, and also the productivity of the timepiece component 10 can be further enhanced.

The first region 11 and the second region 12 may be any as long as these regions are constituted by the first materials, respectively, and the combination of the materials is not particularly limited, and the first region 11 and the second region 12 may have the same composition or may have different compositions, however, it is preferred that the first region 11 is constituted by TiN, and the second region 12 is constituted by a metal material containing Ti, Cr, Al, or Fe.

According to this, a particularly highly luxurious gold color can be expressed.

### Fifth Embodiment

Next, a timepiece component according to a fifth embodiment will be described.

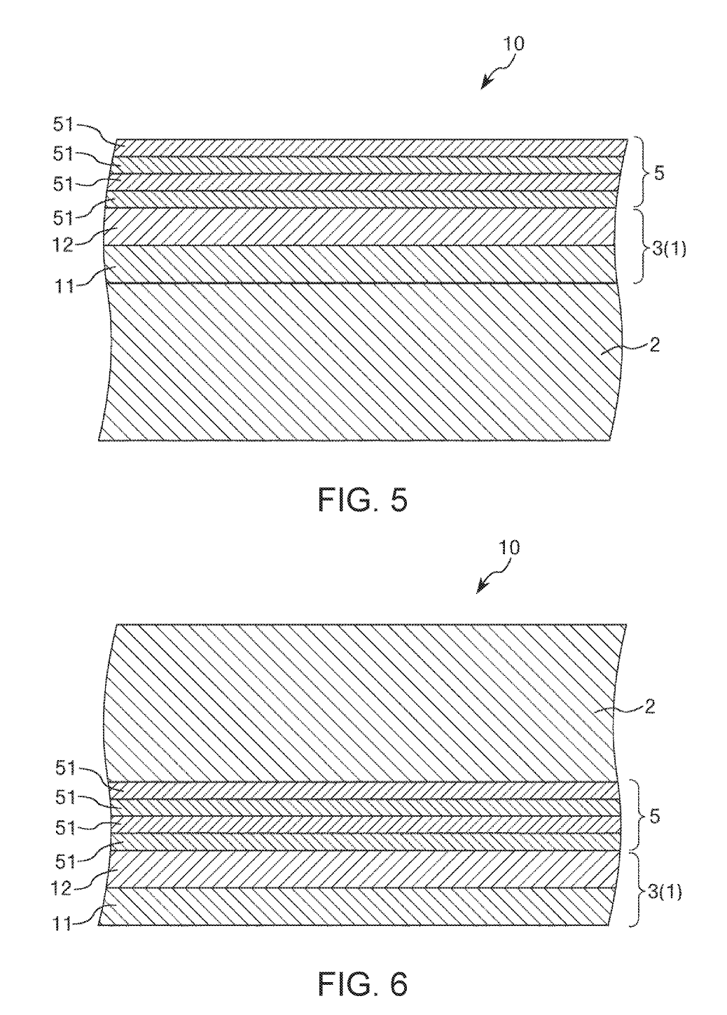

FIG. 5 is a cross-sectional view schematically showing the fifth embodiment of the timepiece component according to the invention. In the following description, different points from the above-mentioned embodiments will be mainly described, and the description of the same matter will be omitted.

In a timepiece component 10 according to this embodiment, a substrate 2 which is constituted by a material other than the first material, a coating film 3 (metallic luster portion 1) which is constituted by the first material, and a toning film 5 which covers the coating film 3 (metallic luster portion 1) are stacked in this order, and the metallic luster portion 1 includes a first region 11 and a second region 12 which is provided in the form of a layer overlapping with the first region 11 on a side closer to the toning film 5 than the first region 11, and the second region 12 is constituted by a material different from that of the first region 11. That is, the timepiece component 10 of this embodiment is the same as that of the above-mentioned fourth embodiment except that the substrate 2 does not constitute the metallic luster portion 1, and also the coating film 3 serving as the metallic luster portion 1 includes the first region 11 (first layer) and the second region 12 (second layer).

By providing the first region 11 in the form of a layer, the range of choices for the constituent material or the like of the substrate 2 and the first region 11 is expanded, and for example, even a material which is difficult to cast or the like can be favorably used. Further, the amount of a metal material used in the timepiece component 10 as a whole can be further decreased.

The thickness of the first region 11 is preferably 20 nm or more and 1500 nm or less, more preferably 25 nm or more and 1000 nm or less, further more preferably 30 nm or more and 500 nm or less.

According to this, the luster and aesthetic property of the timepiece component 10 as a whole can be further enhanced, and also unintended peel-off or the like of the first region 11 can be more effectively prevented, and therefore, the durability of the timepiece component 10 can be further enhanced, and also the productivity of the timepiece component 10 can be further enhanced.

### Sixth Embodiment

Next, a timepiece component according to a sixth embodiment will be described.

FIG. 6 is a cross-sectional view schematically showing the sixth embodiment of the timepiece component according to the invention. In the following description, different points from the above-mentioned embodiments will be mainly described, and the description of the same matter will be omitted.

In a timepiece component 10 according to this embodiment, a substrate 2 has a light transmission property, and the substrate 2, a toning film 5, and a coating film 3 (metallic luster portion 1) which includes a second region 12 and a first region 11 are stacked in this order. That is, the timepiece component 10 according to this embodiment is the same as that of the fifth embodiment except that the placement of the constituent members is different. Further, the timepiece component 10 of this embodiment is the same as that of the above-mentioned third embodiment except that the coating film 3 (metallic luster portion 1) is different.

The timepiece component 10 may be any as long as it is a component constituting a timepiece, but is preferably a component which can be visually recognized from the outside when using the timepiece, and specific examples thereof include a crystal, a case, a bezel, a back cover, a band (including a band block, a band clasp, a buckle, a band/bangle attachment/detachment mechanism, etc.), a dial, timepiece hands, a rotor, a crown (for example, a screw-lock crown, etc.), a button, a dial ring, and a parting plate, and above all, the timepiece component 10 is preferably a crystal, a dial, a case, or a band.

These components (timepiece components) greatly affect the appearance of a timepiece as a whole, and therefore, by applying the invention to these components, the aesthetic property of the timepiece as a whole can be further enhanced.

### Timepiece

Next, a timepiece according to the invention will be described.

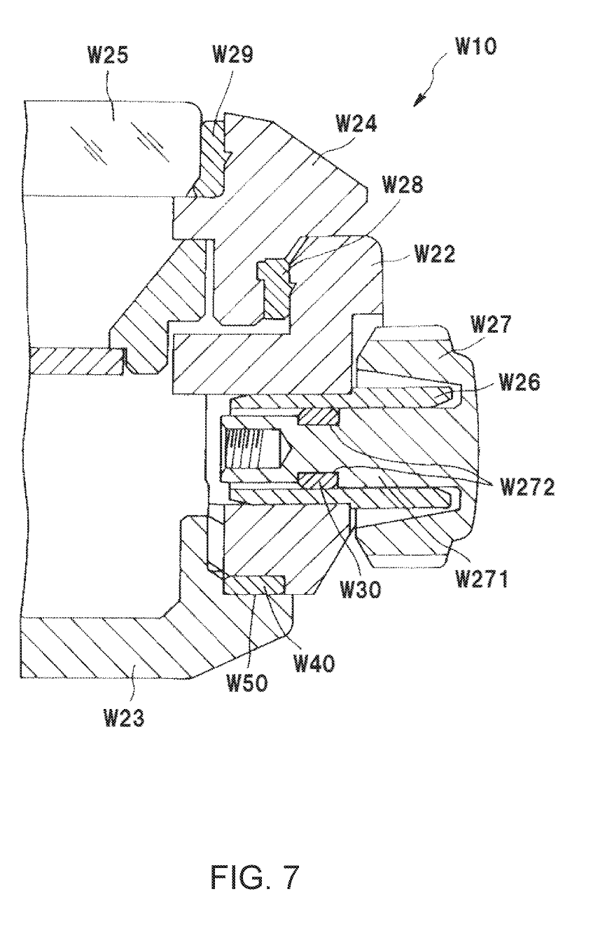

FIG. 7 is a partial cross-sectional view schematically showing a preferred embodiment of a timepiece (wristwatch) according to the invention.

A wristwatch (timepiece) W10 according to this embodiment includes a barrel (case) W22, a back cover W23, a bezel (frame) W24, and a glass plate (crystal) W25. Further, in the case W22, a movement (for example, a movement with a dial and hands) not shown in the drawing is housed.

In the barrel W22, a winding stem pipe W26 is fitted and fixed, and in this winding stem pipe W26, a shaft W271 of a crown W27 is rotatably inserted.

The barrel W22 and the bezel W24 are fixed to each other with a plastic packing W28, and the bezel W24 and the glass plate W25 are fixed to each other with a plastic packing W29.

In the barrel W22, the back cover W23 is fitted (or threadedly engaged), and in a joint portion (seal portion) W50 of these members, a ring-shaped rubber packing (back cover packing) W40 is inserted in a compressed state. According to this configuration, the seal portion W50 is liquid-tightly sealed, whereby a water-proof function is obtained.

A groove W272 is formed on the outer periphery in the middle of the shaft W271 of the crown W27, and in this groove W272, a ring-shaped rubber packing (crown packing) W30 is fitted. The rubber packing W30 is in close contact with the inner peripheral surface of the winding stem pipe W26 and compressed between the inner peripheral surface and the inner surface of the groove W272. According to this configuration, liquid-tight sealing is provided between the crown W27 and the winding stem pipe W26, so that a water-proof function is obtained. When the crown W27 is rotated, the rubber packing W30 rotates along with the shaft W271 and slides in the circumferential direction while being in close contact with the inner peripheral surface of the winding stem pipe W26.

In the wristwatch W10 as the timepiece according to the invention, at least one of the constituent components is constituted by the timepiece component according to the invention as described above. In other words, the timepiece according to the invention includes the timepiece component according to the invention.

Accordingly, the wristwatch W10 having an excellent appearance (an appearance exhibiting a metallic luster) can be provided even without using a noble metal as a main material.

Hereinabove, preferred embodiments of the invention have been described, however, the invention is not limited thereto.

For example, in the timepiece component and the timepiece according to the invention, the configuration of each portion can be replaced with an arbitrary configuration exhibiting a similar function, and also an arbitrary configuration can be added.

For example, at least one intermediate layer may be provided between the metallic luster portion and the toning film or between the substrate and the coating film.

Further, in the above-mentioned fourth, fifth, and sixth embodiments, the metallic luster portion has been described as a portion which includes the first region and the second region, however, the metallic luster portion may further include a third region which is different from the first region and the second region.

Further, in the above-mentioned embodiments, the configuration in which the toning film is provided on one surface side of the metallic luster portion has been representatively described, however, the toning film may be provided on the surfaces on both sides of the metallic luster portion.

Further, a coat layer (protective layer) or the like which imparts corrosion resistance, weather resistance, water resistance, oil resistance, scratch resistance, wear resistance, discoloration resistance, or the like, and improves an antirust effect, an antifouling effect, an antifogging effect, an anti-scratch effect, or the like may be formed on at least a part of the surface of the timepiece component. Such a coat layer may be removed when the timepiece component is used or the like.

### EXAMPLES

Next, specific examples of the invention will be described.

### [1] Production of Timepiece Component

### Example 1

First, a substrate (metallic luster portion) having the shape of a dial was fabricated by punching molding of an SUS304 plate, and thereafter, a necessary portion was cut and polished. The obtained substrate had a substantially disk shape with a diameter of about 27 mm and a thickness of about 0.5 mm.

Subsequently, this substrate was washed. In the washing of the substrate, first, alkaline electrolytic degreasing was performed for 30 seconds, and thereafter, neutralization for 10 seconds, washing with water for 10 seconds, and washing with pure water for 10 seconds were performed.

Subsequently, a toning film constituted by a multilayer film of a metal oxide was formed on one surface of the substrate by ion plating, whereby a dial as a timepiece component was obtained.

The toning film was formed as a film in which a TiO₂ layer (thickness: 50 nm), a SiO₂ layer (thickness: 103 nm), a TiO₂ layer (thickness: 61 nm), a SiO₂ layer (thickness: 40 nm), a TiO₂ layer (thickness: 30 nm), a SiO₂ layer (thickness: 87 nm), a TiO₂ layer (thickness: 116 nm), and a SiO₂ layer (thickness: 76nm) were stacked in this order from the substrate side.

### Example 2

First, a substrate having the shape of a dial was fabricated by compression molding using a polycarbonate, and thereafter, a necessary portion was cut and polished. The obtained substrate had a substantially disk shape with a diameter of about 27 mm and a thickness of about 0.5 mm.

Subsequently, this substrate was washed. In the washing of the substrate, first, alkaline immersion degreasing was performed for 30 seconds, and thereafter, neutralization for 10 seconds, washing with water for 10 seconds, and washing with pure water for 10 seconds were performed.

Subsequently, a coating film (metallic luster portion) having a thickness of 160 nm constituted by TiN was formed on one surface of the substrate by ion plating.

Subsequently, a toning film constituted by a multilayer film of a metal oxide was formed on the surface of the coating film (metallic luster portion) by ion plating, whereby a dial as a timepiece component was obtained.

The toning film was formed as a film in which a SiO₂ layer (thickness: 82 nm), a Ta₂O₅ layer (thickness: 63 nm), a SiO₂ layer (thickness: 93 nm), and a Ta₂O₅ layer (thickness: 105 nm) were stacked in this order from the coating film (metallic luster portion) side.

### Example 3

A timepiece component (dial) was produced in the same manner as in the above-mentioned Example 2 except that the configuration of the coating film (metallic luster portion) and the toning film was changed as shown in Table 1 by adjusting the film forming conditions when forming the coating film (metallic luster portion) and the film forming conditions when forming the toning film.

### Example 4

First, an inorganic glass substrate having the shape of a crystal was prepared.

Subsequently, this substrate was washed. In the washing of the substrate, first, alkaline immersion degreasing was performed for 30 seconds, and thereafter, neutralization for 10 seconds, washing with water for 10 seconds, and washing with pure water for 10 seconds were performed.

Subsequently, a toning film constituted by a multilayer film of a metal oxide was formed on one surface of the substrate by ion plating.

The toning film was formed as a film in which a TiO₂ layer (thickness: 14 nm), a SiO₂ layer (thickness: 93 nm), a TiO₂ layer (thickness: 45 nm), a SiO₂ layer (thickness: 30nm), a TiO₂ layer (thickness: 58 nm), a SiO₂ layer (thickness: 106 nm), and a TiO₂ layer (thickness: 53 nm) were stacked in this order from the substrate side.

Subsequently, a coating film (metallic luster portion) having a thickness of 52 nm constituted by Ti was formed on the surface of the toning film by ion plating, whereby a crystal as a timepiece component was obtained.

### Example 5

First, a substrate (a first region of a metallic luster portion) having the shape of a dial was fabricated by punching molding of an aluminum plate, and thereafter, a necessary portion was cut and polished. The obtained substrate had a substantially disk shape with a diameter of about 27 mm and a thickness of about 0.5 mm.

Subsequently, this substrate was washed. In the washing of the substrate, first, alkaline electrolytic degreasing was performed for 30 seconds, and thereafter, neutralization for 10 seconds, washing with water for 10 seconds, and washing with pure water for 10 seconds were performed.

Subsequently, a coating film (a second region of a metallic luster portion) having a thickness of 160 nm constituted by TiN was formed on one surface of the substrate by ion plating.

Subsequently, a toning film constituted by a multilayer film of a metal oxide was formed on the surface of the coating film by ion plating, whereby a dial as a timepiece component was obtained.

The toning film was formed as a film in which a SiO₂ layer (thickness: 82 nm), a Ta₂O₅ layer (thickness: 63 nm), a SiO₂ layer (thickness: 93 nm), and a Ta₂O₅ layer (thickness: 105 nm) were stacked in this order from the coating film side.

### Example 6

A timepiece component (dial) was produced in the same manner as in the above-mentioned Example 5 except that the configuration of the toning film was changed as shown in Table 1 by adjusting the film forming conditions when forming the toning film.

### Example 7

First, a substrate having the shape of a dial was fabricated by compression molding using a polycarbonate, and thereafter, a necessary portion was cut and polished. The obtained substrate had a substantially disk shape with a diameter of about 27 mm and a thickness of about 0.5 mm.

Subsequently, this substrate was washed. In the washing of the substrate, first, alkaline immersion degreasing was performed for 30 seconds, and thereafter, neutralization for 10 seconds, washing with water for 10 seconds, and washing with pure water for 10 seconds were performed.

Subsequently, a coating film (metallic luster portion) as a stacked body in which a first region (first layer) and a second region (second layer) were stacked in this order was formed on one surface of the substrate by ion plating.

The first region (first layer) was constituted by TiN and had a thickness of 162 nm. The second region (second layer) was constituted by Al and had a thickness of 6 nm.

Subsequently, a toning film constituted by a multilayer film of a metal oxide was formed on the surface of the coating film (metallic luster portion) by ion plating, whereby a dial as a timepiece component was obtained.

The toning film was formed as a film in which a Ta₂O₅ layer (thickness: 120 nm) and a SiO₂ layer (thickness: 44 nm) were stacked in this order from the coating film (metallic luster portion) side.

### Example 8

First, an inorganic glass substrate having the shape of a crystal was prepared.

Subsequently, this substrate was washed. In the washing of the substrate, first, alkaline immersion degreasing was performed for 30 seconds, and thereafter, neutralization for 10 seconds, washing with water for 10 seconds, and washing with pure water for 10 seconds were performed.

Subsequently, a toning film constituted by a multilayer film of a metal oxide was formed on one surface of the substrate by ion plating.

The toning film was formed as a film in which a Ta₂O₅ layer (thickness: 79 nm) and a SiO₂ layer (thickness: 110 nm) were stacked in this order from the substrate side.

Subsequently, a coating film (metallic luster portion) as a stacked body in which a second region (second layer) and a first region (first layer) were stacked in this order was formed on the surface of the toning film by ion plating, whereby a crystal as a timepiece component was obtained.

The second region (second layer) was constituted by Al and had a thickness of 5 nm. The first region (first layer) was constituted by TiN and had a thickness of 100 nm.

### Example 9

First, a substrate (a first region of a metallic luster portion) having the shape of a dial was fabricated by punching molding of an aluminum plate, and thereafter, a necessary portion was cut and polished. The obtained substrate had a substantially disk shape with a diameter of about 27 mm and a thickness of about 0.5 mm.

Subsequently, this substrate was washed. In the washing of the substrate, first, alkaline electrolytic degreasing was performed for 30 seconds, and thereafter, neutralization for 10 seconds, washing with water for 10 seconds, and washing with pure water for 10 seconds were performed.

Subsequently, a coating film (a second region of a metallic luster portion) having a thickness of 160 nm constituted by TiN was formed on one surface of the substrate by ion plating.

Subsequently, a toning film constituted by a multilayer film of a metal oxide was formed on the surface of the coating film by ion plating, whereby a dial as a timepiece component was obtained.

The toning film was formed as a film in which a SiO₂ layer (thickness: 92 nm), a Nb₂O₅ layer (thickness: 50 nm), a SiO₂ layer (thickness: 108 nm), and a Nb₂O₅ layer (thickness: 90 nm) were stacked in this order from the coating film side.

### Example 10

First, a substrate (a first region of a metallic luster portion) having the shape of a dial was fabricated by punching molding of an aluminum plate, and thereafter, a necessary portion was cut and polished. The obtained substrate had a substantially disk shape with a diameter of about 27 mm and a thickness of about 0.5 mm.

Subsequently, this substrate was washed. In the washing of the substrate, first, alkaline electrolytic degreasing was performed for 30 seconds, and thereafter, neutralization for 10 seconds, washing with water for 10 seconds, and washing with pure water for 10 seconds were performed.

Subsequently, a coating film (a second region of a metallic luster portion) having a thickness of 160 nm constituted by TiN was formed on one surface of the substrate by ion plating.

Subsequently, a toning film constituted by a multilayer film of a metal oxide was formed on the surface of the coating film by ion plating, whereby a dial as a timepiece component was obtained.

The toning film was formed as a film in which a SiO₂ layer (thickness: 79 nm), a ZrO₂ layer (thickness: 70 nm), a SiO₂ layer (thickness: 92 nm), and a ZrO₂ layer (thickness: 110 nm) were stacked in this order from the coating film side.

### Examples 11 to 13

A timepiece component (dial) was produced in the same manner as in the above-mentioned Example 7 except that the configuration of the coating film (metallic luster portion) and the toning film was changed as shown in Table 1 by adjusting the film forming conditions when forming the coating film (metallic luster portion) and the film forming conditions when forming the toning film.

### Example 14

First, a substrate (a first region of a metallic luster portion) having the shape of a dial was fabricated by punching molding of an SUS304 plate, and thereafter, a necessary portion was cut and polished. The obtained substrate had a substantially disk shape with a diameter of about 27 mm and a thickness of about 0.5 mm.

Subsequently, this substrate was washed. In the washing of the substrate, first, alkaline electrolytic degreasing was performed for 30 seconds, and thereafter, neutralization for 10 seconds, washing with water for 10 seconds, and washing with pure water for 10 seconds were performed.

Subsequently, a coating film (a second region of a metallic luster portion) having a thickness of 100 nm constituted by TiCN was formed on one surface of the substrate by ion plating.

Subsequently, a toning film constituted by a multilayer film of a metal oxide was formed on the surface of the coating film by ion plating, whereby a dial as a timepiece component was obtained.

The toning film was formed as a film in which a Ta₂O₅ layer (thickness: 113 nm) and a SiO₂ layer (thickness: 77 nm) were stacked in this order from the coating film side.

### Example 15

A timepiece component (dial) was produced in the same manner as in the above-mentioned Example 14 except that the configuration of the coating film (the second region of the metallic luster portion) and the toning film was changed as shown in Table 1 by adjusting the film forming conditions when forming the coating film (the second region of the metallic luster portion) and the film forming conditions when forming the toning film.

### Example 16

A timepiece component (dial) was produced in the same manner as in the above-mentioned Example 2 except that the configuration of the coating film (metallic luster portion) and the toning film was changed as shown in Table 1 by adjusting the film forming conditions when forming the coating film (metallic luster portion) and the film forming conditions when forming the toning film.

### Example 17

A timepiece component (dial) was produced in the same manner as in the above-mentioned Example 14 except that the configuration of the coating film (the second region of the metallic luster portion) and the toning film was changed as shown in Table 1 by adjusting the film forming conditions when forming the coating film (the second region of the metallic luster portion) and the film forming conditions when forming the toning film.

### Example 18

A timepiece component (dial) was produced in the same manner as in the above-mentioned Example 2 except that the configuration of the coating film (metallic luster portion) and the toning film was changed as shown in Table 1 by adjusting the film forming conditions when forming the coating film (metallic luster portion) and the film forming conditions when forming the toning film.

### Comparative Example 1

A timepiece component (dial) was produced in the same manner as in the above-mentioned Example 1 except that the toning film was not formed.

### Comparative Example 2

A disk-shaped member made of Au was fabricated by casting, and thereafter, a necessary portion was cut and polished, whereby a dial (timepiece component) with the following dimension: a diameter of about 27 mm and a thickness of about 0.5 mm was obtained. That is, the timepiece component of this Comparative Example was constituted by a pure gold material.

The configurations of the timepiece components of the respective Examples and Comparative Examples are shown together in Table 1. The thickness of each portion excluding the substrate is shown in parentheses. Further, in the table, the polycarbonate is denoted by “PC” and the inorganic glass is denoted by “G”. Further, with respect to each portion constituting the timepiece component, the content of the component shown in the table was all 99.9 mass % or more in all cases.

Further, with respect to those including a layer constituted by TiC among the respective Examples, the content of C (carbon) in the layer was within the range of 50 mass % or more and 60 mass % or less in all cases.

Further, with respect to those including a layer constituted by TiCN among the respective Examples, the content of C (carbon) in the layer was within the range of 5 mass % or more and 15 mass % or less, and the content of N (nitrogen) in the layer was within the range of 1 mass % or more and 5 mass % or less in all cases.

TABLE 1

| | |
|---|---|
| Example 1 | SUS304 (substrate)/TiO₂ (50 nm)/SiO₂ (103 nm)/TiO₂ (61 nm)/SiO₂ (40 nm)/TiO₂ (30 nm)/ |
| | SiO₂ (87 nm)/TiO₂ (116 nm)/SiO₂ (76 nm) |
| Example 2 | PC (substrate)/TiN (160 nm)/SiO₂ (82 nm)/Ta₂O₅ (63 nm)/SiO₂ (93 nm)/Ta₂O₅ (105 nm) |
| Example 3 | PC (substrate)/Ti (75 nm)/TiO₂ (50 nm)/SiO₂ (110 nm)/TiO₂ (64 nm)/SiO₂ (32 nm)/TiO₂ |
| | (38 nm)/SiO₂ (97 nm)/TiO₂ (28 nm)/SiO₂ (137 nm) |
| Example 4 | G (substrate)/TiO₂ (14 nm)/SiO₂ (93 nm)/TiO₂ (45 nm)/SiO₂ (30 nm)/TiO₂ (58 nm)/SiO₂ |
| | (106 nm)/TiO₂ (53 nm)/Ti (52 nm) |
| Example 5 | Al (substrate)/TiN (160 nm)/SiO₂ (82 nm)/Ta₂O₅ (63 nm)/SiO₂ (93 nm)/Ta₂O₅ (105 nm) |
| Example 6 | Al (substrate)/TiN (160 nm)/SiO₂ (63 nm)/TiO₂ (63 nm)/SiO₂ (128 nm)/TiOₓ (67 nm)/SiO₂ |
| | (56 nm) |
| Example 7 | PC (substrate)/TiN (162 nm)/Al (6 nm)/Ta₂O₅ (120 nm)/SiO₂ (44 nm) |
| Example 8 | G (substrate)/Ta₂O₅ (79 nm)/SiO₂ (110 nm)/Al (5 nm)/TiN (100 nm) |
| Example 9 | Al (substrate)/TiN (160 nm)/SiO₂ (92 nm)/Nb₂O₅ (50 nm)/SiO₂ (108 nm)/Nb₂O₅ (90 nm) |
| Example 10 | Al (substrate)/TiN (160 nm)/SiO₂ (79 nm)/ZrO₂ (70 nm)/SiO₂ (92 nm)/ZrO₂ (110 nm) |
| Example 11 | PC (substrate)/TiN (162 nm)/Ti (6 nm)/Al₂O₃ (67 nm)/Ta₂O₅ (77 nm) |
| Example 12 | PC (substrate)/TiN (162 nm)/Cr (58 nm)/SiO₂ (114 nm)/HfO₂ (71 nm)/SiO₂ (215 nm) |
| Example 13 | PC (substrate)/TiN (162 nm)/Fe (7 nm)/SiO₂ (84 nm)/Ta₂O₅ (76 nm)/SiO₂ (218 nm) |
| Example 14 | SUS304 (substrate)/TiCN (100 nm)/Ta₂O₅ (113 nm)/SiO₂ (77 nm) |
| Example 15 | SUS304 (substrate)/CrN (90 nm)/SiO₂ (118 nm)/TiO₂ (53 nm)/SiO₂ (125 nm)/TiO₂ (65 nm)/ |
| | SiO₂ (60 nm) |
| Example 16 | PC (substrate)/CrCN (90 nm)/TiO₂ (50 nm)/SiO₂ (110 nm)/TiO₂ (70 nm)/SiO₂ (32 nm)/TiO₂ |
| | (32 nm)/SiO₂ (109 nm)/TiO₂ (26 nm)/SiO₂ (136 nm) |
| Example 17 | SUS304 (substrate)/TiC (900 nm)/TiO₂ (68 nm)/SiO₂ (106 nm) |
| Example 18 | PC (substrate)/CrC (80 nm)/TiO₂ (50 nm)/SiO₂ (108 nm)/TiO₂ (63 nm)/SiO₂ (35 nm)/TiO₂ |
| | (37 nm)/SiO₂ (98 nm)/TiO₂ (28 nm)/SiO₂ (138 nm) |
| Comparative | Al (substrate) |
| Example 1 | |
| Comparative | Au (substrate) |
| Example 2 | |

### [2] Evaluation

The respective timepiece components produced in the above-mentioned respective Examples and Comparative Examples were observed by visual inspection.

As a result, the timepiece components of the above-mentioned respective Examples all exhibited a very luxurious and excellent appearance. In particular, the timepiece components of Examples 2, 5, 6, 7, 8, 9, 10, 11, 12, 13, and 15 exhibited a luxurious gold color in the same manner as the timepiece component of Comparative Example 2, and in Examples 1, 3, 4, 16, 17, and 18, an excellent appearance exhibiting a luxurious bluish luster was obtained. Further, in the timepiece component of Example 14 in which the metallic luster portion is constituted by a carbonitride of Ti, a luxurious appearance similar to pink gold was obtained. Further, when a standard light source D50 was used, the timepiece component of Example 1 had an L* value of 37.2, an a* value of 42.1, and a b* value of −87.2, the timepiece component of Example 2 had an L* value of 86.0, an a* value of 13.6, and a b* value of 41.9, the timepiece component of Example 3 had an L* value of 42.9, an a* value of 37.8, and a b* value of −85.2, the timepiece component of Example 4 had an L* value of 30.4, an a* value of 55.4, and a b* value of −103.3, the timepiece component of Example 5 had an L* value of 86.0, an a* value of 13.6, and a b* value of 41.9, the timepiece component of Example 6 had an L* value of 87.5, an a* value of 10.1, and a b* value of 41.4, the timepiece component of Example 7 had an L* value of 85.9, an a* value of 0.9, and a b* value of 35.6, the timepiece component of Example 8 had an L* value of 86.7, an a* value of 2.3, and a b* value of 36.3, the timepiece component of Example 9 had an L* value of 88.2, an a* value of 12.3, and a b* value of 43.3, the timepiece component of Example 10 had an L* value of 84.4, an a* value of 16.2, and a b* value of 38.4, the timepiece component of Example 11 had an L* value of 81.8, an a* value of 10.1, and a b* value of 40.1, the timepiece component of Example 12 had an L* value of 86.1, an a* value of 8.3, and a b* value of 35.3, the timepiece component of Example 13 had an L* value of 80.4, an a* value of 12.0, and a b* value of 34.4, the timepiece component of Example 14 had an L* value of 85.4, an a* value of 10.4, and a b* value of 23.9, the timepiece component of Example 15 had an L* value of 89.3, an a* value of 8.0, and a b* value of 35.3, the timepiece component of Example 16 had an L* value of 48.7, an a* value of 28.8, and a b* value of −77.6, the timepiece component of Example 17 had an L* value of 25.5, an a* value of 2.2, and a b* value of −34.4, and the timepiece component of Example 18 had an L* value of 40.5, an a* value of 41.7, and a b* value of −88.8.

On the other hand, in Comparative Example 1, only a poor luxurious appearance was obtained. In Comparative Example 2, although an excellent appearance was exhibited, a large amount of a noble metal was required for the production of the timepiece component.

The timepiece components of Examples 1 to 3, 5 to 7, and 9 to 18 were observed from the surface on the opposite side to the substrate, and the timepiece components of Examples 4 and 8 were observed from the surface on the substrate side.

When timepiece components (cases and bands) were produced in the same manner as in the above-mentioned respective Examples and Comparative Examples except that the shape of the substrate was changed to the shape of a case and a band, and evaluation was performed in the same manner as described above, the same results as described above were obtained.

Further, when timepiece components were produced in the same manner as in the above-mentioned Examples 1, and 5 to 8 except that Cr was used in place of Al as the material of the metallic luster portion, and evaluation was performed in the same manner as described above, the same results as described above were obtained.

Further, when timepiece components were produced in the same manner as in the above-mentioned Example 7 and 8 except that Ti, Cr, or Fe was used in place of Al as the constituent material of the second region, and evaluation was performed in the same manner as described above, the same results as described above were obtained.

Further, wristwatches as shown in FIG. 7 were assembled using the timepiece components produced in the above-mentioned respective Examples and Comparative Examples. When these wristwatches were evaluated in the same manner as described above, the same results as described above were obtained.

The entire disclosure of Japanese Patent Application Nos. 2017-014555, filed Jan. 30, 2017 and 2017-216498, filed Nov. 9, 2017 are expressly incorporated by reference herein.

What is claimed is:

1. A timepiece component, comprising:
a metallic luster portion which is constituted by a first material containing a nitride or a carbide of Ti, a nitride or a carbide of Cr, or a metal material, and exhibits a metallic luster; and
a toning film which is constituted by a multilayer film of a metal oxide, and has a function of adjusting a color tone.

2. The timepiece component according to claim 1, wherein the metallic luster portion is a substrate constituted by the first material.

3. The timepiece component according to claim 1, wherein the metallic luster portion is a coating film provided on a substrate constituted by a material containing substantially no nitride or carbide of Ti, nitride or carbide of Cr, or metal material.

4. The timepiece component according to claim 1, wherein the metallic luster portion has a thickness of 30 nm or more.

5. The timepiece component according to claim 1, wherein the toning film includes a layer constituted by a material containing at least one member selected from the group consisting of Ta₂O₅, SiO₂, TiO₂, Al₂O₃, ZrO₂, Nb₂O₅, and HfO₂.

6. The timepiece component according to claim 1, wherein the toning film has a thickness of 100 nm or more and 2000 nm or less.

7. The timepiece component according to claim 1, wherein each layer constituting the toning film has a thickness of 10 nm or more and 300 nm or less.

8. The timepiece component according to claim 1, wherein the metallic luster portion is constituted by a material containing one of Cr and Al.

9. The timepiece component according to claim 1, wherein
the metallic luster portion includes a first region and a second region which is provided in the form of a layer overlapping with the first region on a side closer to the toning film than the first region, and
the second region is constituted by a material different from that of the first region.

10. The timepiece component according to claim 9, wherein the
the first region is constituted by TiN, and
the second region is constituted by a metal material containing Ti, Cr, Al, or Fe.

11. The timepiece component according to claim 9, wherein the first region is provided in the form of a layer.

12. The timepiece component according to claim 1, wherein the timepiece component is a crystal, a dial, a case, or a band.

13. A timepiece, comprising the timepiece component according to claim 1.

14. A timepiece, comprising the timepiece component according to claim 2.

15. A timepiece, comprising the timepiece component according to claim 3.

16. A timepiece, comprising the timepiece component according to claim 4.

17. A timepiece, comprising the timepiece component according to claim 5.

18. A timepiece, comprising the timepiece component according to claim 6.

19. A timepiece, comprising the timepiece component according to claim 7.

20. A timepiece, comprising the timepiece component according to claim 8.
